(19) United States
(12) Patent Application Publication
(10) Pub. No.: US 2013/0080472 A1
(43) Pub. Date: Mar. 28, 2013

(54) TRANSLATING NATURAL LANGUAGE QUERIES

(71) Applicants: Ira Cohen, Modiin (IL); Refael Dakar, Ramat Gan (IL); Eli Mordechai, Modiin (IL); Ohad Assulin, Tel-Aviv (IL)

(72) Inventors: Ira Cohen, Modiin (IL); Refael Dakar, Ramat Gan (IL); Eli Mordechai, Modiin (IL); Ohad Assulin, Tel-Aviv (IL)

(21) Appl. No.: 13/247,266

(22) Filed: Sep. 28, 2011

(51) Int. Cl. G06F 17/30

(52) U.S. Cl. 707/794; 707/E17.128

(57) ABSTRACT

A system and related method to process natural queries is provided. In one aspect, it is determined whether any portion of the natural language query matches one of a plurality of semantic keywords. In another aspect, the natural language query is translated into at least one database query. In a further aspect, the database query may be executed in a database arranged in accordance with the database model.

### BACKGROUND

Natural language interfaces are utilized to translate questions written in a natural language into a suitable database query language, such as structured query language (“SQL”). In turn, a database management system returns the results of the query to a user. SQL is a popular programming language used to submit database queries to a database management system.

### BRIEF DESCRIPTION OF THE DRAWINGS

FIG. 1 is an illustrative system in accordance with aspects of the application.

FIG. 2 is a close up illustration of a computer apparatus in accordance with aspects of the application.

FIG. 3 is a flow diagram in accordance with aspects of the application.

FIG. 4 is an illustrative data base model in accordance with aspects of the application.

FIG. 5 is an illustrative data structure in accordance with aspects of the application.

FIG. 6 is an additional illustrative data structure in accordance with aspects of the application.

### DETAILED DESCRIPTION

### Introduction

Many natural language interfaces attempt to generate one corresponding database query whose results often differ from the intentions of the user. Furthermore, conventional interfaces do not adequately account for ambiguities in the natural language query and the database. Various examples disclosed herein provide a system and method to translate a natural language query into at least one database query. In one aspect, a natural language query may be received. In another aspect, it may be determined whether any portion of the natural language query matches one of a plurality of semantic keywords. Each semantic keyword may represent at least one attribute of a database model. In a further aspect, the semantic keywords may comprise synonymous semantic keywords that represent at least one identical attribute of the database model. In a further example, the at least one database query may use a unique combination of attributes of the database model. Each attribute in the unique combination may be represented by a semantic keyword that matches any portion of the natural language query. The generated database queries may be executed in a database arranged in accordance with the database model.

The aspects, features and advantages of the application will be appreciated when considered with reference to the following description of examples and accompanying figures. The following description does not limit the application; rather, the scope of the application is defined by the appended claims and equivalents. The present disclosure is broken into sections. The first section, labeled “Environment,” describes an illustrative environment in which various examples may be implemented. The second section, labeled “Components,” describes various physical and logical components for implementing various examples. The third section, labeled “Operation,” describes an illustrative process in accordance with the present disclosure.

### Environment

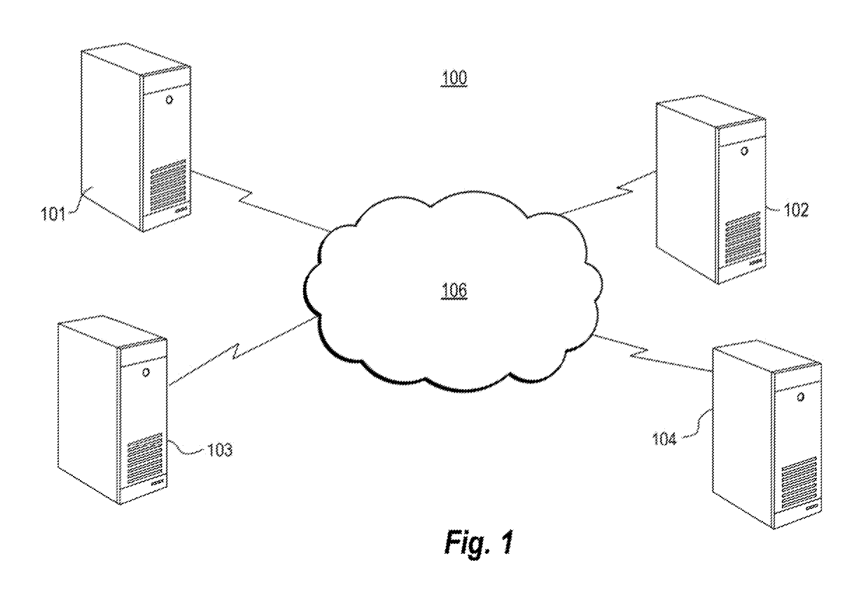

FIG. 1 presents a schematic diagram of an illustrative system 100 depicting various computers 101, 102, 103, and 104 used in a networked configuration. Each computer may comprise any device capable of processing instructions and transmitting data to and from other computers, including a laptop, a full-sized personal computer, a high-end server, or a network computer lacking local storage capability. Moreover, each computer may comprise a mobile device capable of wirelessly exchanging data with a server, such as a mobile phone, a wireless-enabled PDA, or a tablet PC. Each computer apparatus 101, 102, 103, and 104 may include all the components normally used in connection with a computer. For example, each computing device may have a keyboard, a mouse and/or various other types of input devices such as pen-inputs, joysticks, buttons, touch screens, etc., as well as a display, which could include, for instance, a CRT, LCD, plasma screen monitor, TV, projector, etc.

The computers or devices disclosed in FIG. 1 may be interconnected via a network 106, which may be a local area network (“LAN”), wide area network (“WAN”), the Internet, etc. Network 106 and intervening computer devices may also use various protocols including virtual private networks, local Ethernet networks, private networks using communication protocols proprietary to one or more companies, cellular and wireless networks, instant messaging, HTTP and SMTP, and various combinations of the foregoing. Although only a few computers are depicted in FIG. 1, it should be appreciated that a typical network may include a large number of interconnected computers.

### Components

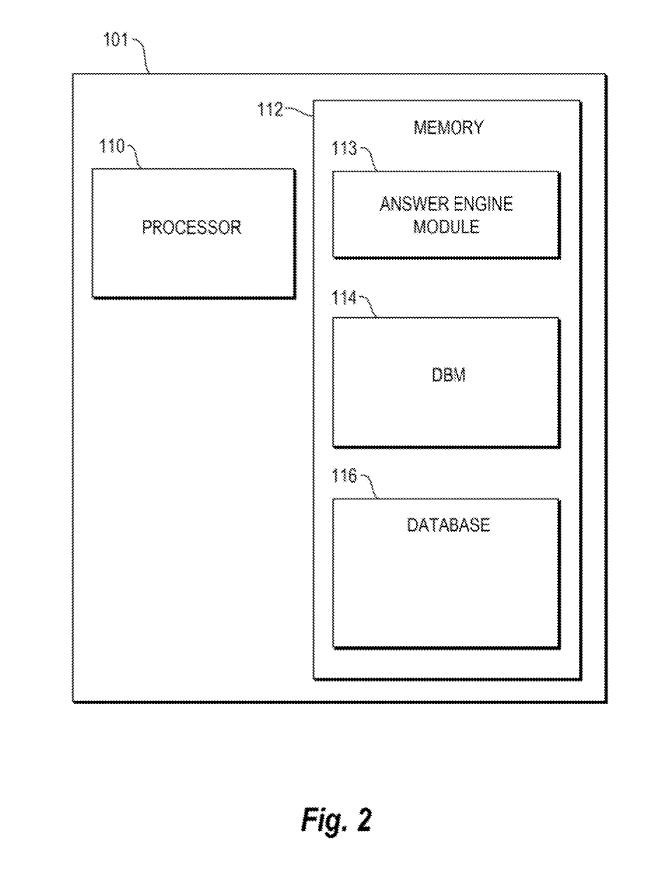

FIG. 2 is a close up illustration of computer apparatus 101. In the example of FIG. 2, computer apparatus 101 is a database server with a processor 110 and memory 112. Memory 112 may store database management (“DBM”) instructions 114 and answer engine module 113, which may be retrieved and executed by processor 110. Furthermore, memory 112 may contain a database 116 containing data that may be retrieved, manipulated, or stored by processor 110. In one example, memory 112 may be a random access memory (“RAM”) device. Alternatively, memory 112 may comprise other types of devices, such as memory provided on floppy disk drives, tapes, and hard disk drives, or other storage devices that may be directly or indirectly coupled to computer apparatus 101. The memory may also include any combination of one or more of the foregoing and/or other devices as well. The processor 110 may be any number of well known processors, such as processors from Intel® Corporation. In another example, the processor may be a dedicated controller for executing operations, such as an application specific integrated circuit (“ASIC”).

Although FIG. 2 functionally illustrates the processor 110 and memory 112 as being within the same block, it will be understood that the processor and memory may actually comprise at least one or multiple processors and memories that may or may not be stored within the same physical housing. For example, any one of the memories may be a hard drive or other storage media located in a server farm of a data center. Accordingly, references to a processor, computer, or memory will be understood to include references to a collection of processors, computers, or memories that may or may not operate in parallel.

As noted above, computer apparatus 101 may be configured as a database server. In this regard, computer apparatus 101 may be capable of communicating data with a client computer such that computer apparatus 101 uses network 106 to transmit information for presentation to a user of a remote computer. Accordingly, computer apparatus 101 may be used to obtain database information for display via, for example, a web browser executing on computer 102. Computer apparatus 101 may also comprise a plurality of computers, such as a load balancing network, that exchange information with different computers of a network for the purpose of receiving, processing, and transmitting data to multiple client computers. In this instance, the client computers will typically still be at different nodes of the network than any of the computers comprising computer apparatus 101.

The DBM instructions 114 and answer engine module 113 may comprise any set of instructions to be executed directly (such as machine code) or indirectly (such as scripts) by the processor(s). In that regard, the terms “instructions,” “modules” and “programs” may be used interchangeably herein. The instructions may be stored in any computer language or format, such as in object code or modules of source code. Furthermore, it is understood that the instructions may be implemented in the form of hardware, software, or a combination of hardware and software and that the examples herein are merely illustrative.

In one example, the instructions may be part of an installation package that may be executed by processor 110. In this example, memory 112 may be a portable medium such as a CD, DVD, or flash drive or a memory maintained by a server from which the installation package may be downloaded and installed. In another example, the instructions may be part of an application or applications already installed. Here, memory 112 may include integrated memory such as a hard drive.

DBM instructions 114 may configure processor 110 to reply to database queries, to update the database, to provide database usage statistics, or to serve any other database related function. Requests for database access may be transmitted from a remote computer via network 106. For example, computer 104 may be at a sales location communicating new data through network 106. This data may be, for example, new employee, sales, or inventory data. At the same time, computer 103 may be at a corporate office submitting natural language queries to answer engine module 113. As will be discussed below, answer engine module 113 may configure processor 110 to translate the natural language query into a database query for execution in database 116 via DBM instructions 114. The relevant data may be returned to computer 103.

Answer engine module 113 may configure processor 110 to utilize semantic keywords to translate natural language queries into at least one database query. Answer engine module 113 may parse portions of the natural language query and compare each portion to semantic keywords stored in a data structure arranged in memory 112. Furthermore, answer engine module 113 may rank each query or result thereof by relevancy. In one example, a highest ranked database query may generate results that are most relevant to the natural language query and a lowest ranked database query may generate results that are least relevant to the natural language query. As will be, discussed further below, relevancy may be measured at least partially by the number of one to one associations between identified attributes and semantic keywords matching portions of the natural language query.

### Operation

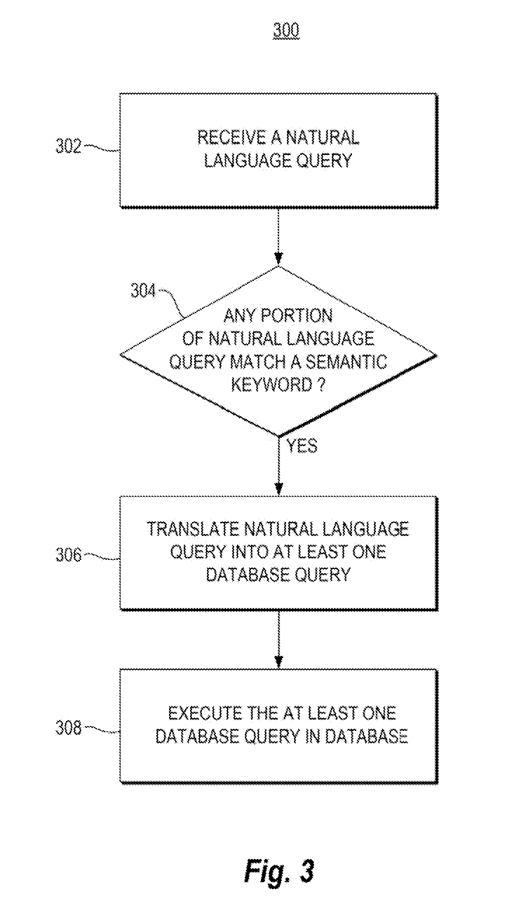

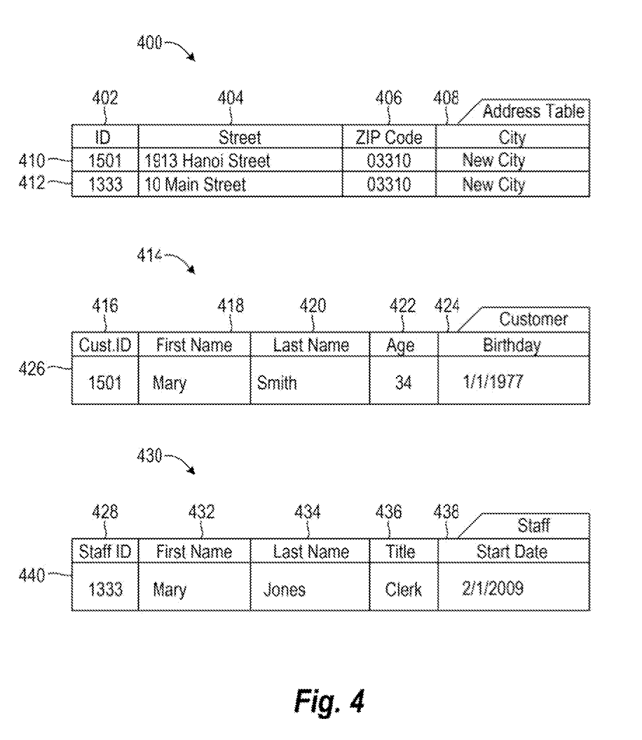

One working example of a system and method to process natural language queries is illustrated in FIGS. 3-6. In particular, FIG. 3 illustrates a flow diagram of a process for handling natural language queries. FIGS. 4-6 show various aspects of natural language to database query translation. The actions shown in FIGS. 4-6 will be discussed below with regard to the flow diagram of FIG. 3.

As shown in block 302 of FIG. 3, a natural language query may be received. The natural language query may be received by answer engine module 113 and may have been entered by a user on a remote computer, such as computer 103. In block 304, it may be determined whether any portion of the natural language query matches a semantic keyword of a plurality of semantic keywords. Each semantic keyword may represent an attribute of the database model arranged in database 116.

Referring to FIG. 4, a simple, illustrative database model of database 116 is shown. Address table 400 may store addresses of different people associated with a business, such as customers or staff. Address table 400 is shown having an identifier column 402, a street column 404, a zip code column 406, and a city column 408. Address table 400 is shown having two rows of data, row 410 and 412. The data of row 410 may comprise a value of 1501 in identifier column 402, a value of “1913 Hanoi Street” in street column 404, a value of “03310” in zip code column 406, and a value of “New City” in city column 408. The data of row 412 may comprise a value of 1333 in identifier column 402, a value of “10 Main Street” in street column 404, a value of “03310” in zip code column 406, and a value of “New City” in city column 408.

Customer table 414 may be utilized to store customer data of a business. Customer table 414 may have a customer identifier column 416, a first name column 418, a last name column 420, an age column 422, and a birthday column 424. Customer table may have one row 426 comprising a value of 1501 in customer identifier column 416, a value of “Mary” in first name column 418, a value of “Smith” in last name column 420, a value of 34 in age column 422, and a value of “Jan. 1, 1977” in birthday column 424. The value 1501 stored in customer identifier column 416 may be used to associate row 426 with row 410 of address table 400, which also contains 1501 in identifier column 402. Accordingly, the address of customer “Mary Smith” may be “1913 Hanoi St. New City 03310.”

Staff table 430 may be used to store staff data of a business. Staff table 430 may have a staff identifier column 428, a first name column 432, a last name column 434, a title column 436, and a start date column 438. Staff table 430 may also have a row 440 comprising a value of 1333 in staff identifier column 428, a value of “Mary” in first name column 432, a value of “Jones” in last name column 434, a value of “Clerk” in title column 436, and a value of “Feb. 1, 2009” in start date column 438. The value 1333 stored in staff table 430 may be used to associate row 440 with row 412 of address table 400, which also contains 1333 in identifier column 402. Thus, the address of staff member “Mary Jones” is “10 Main St. New City 03310.”

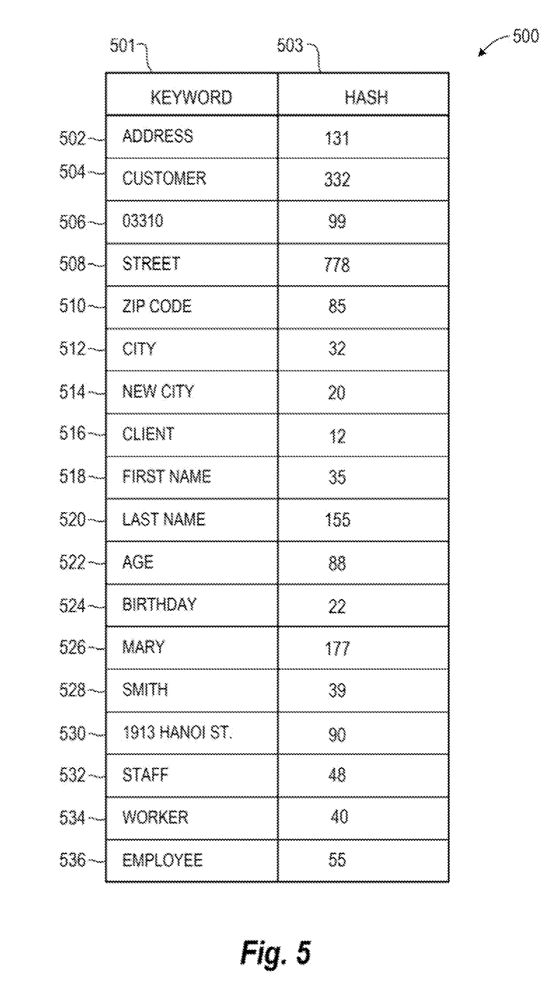

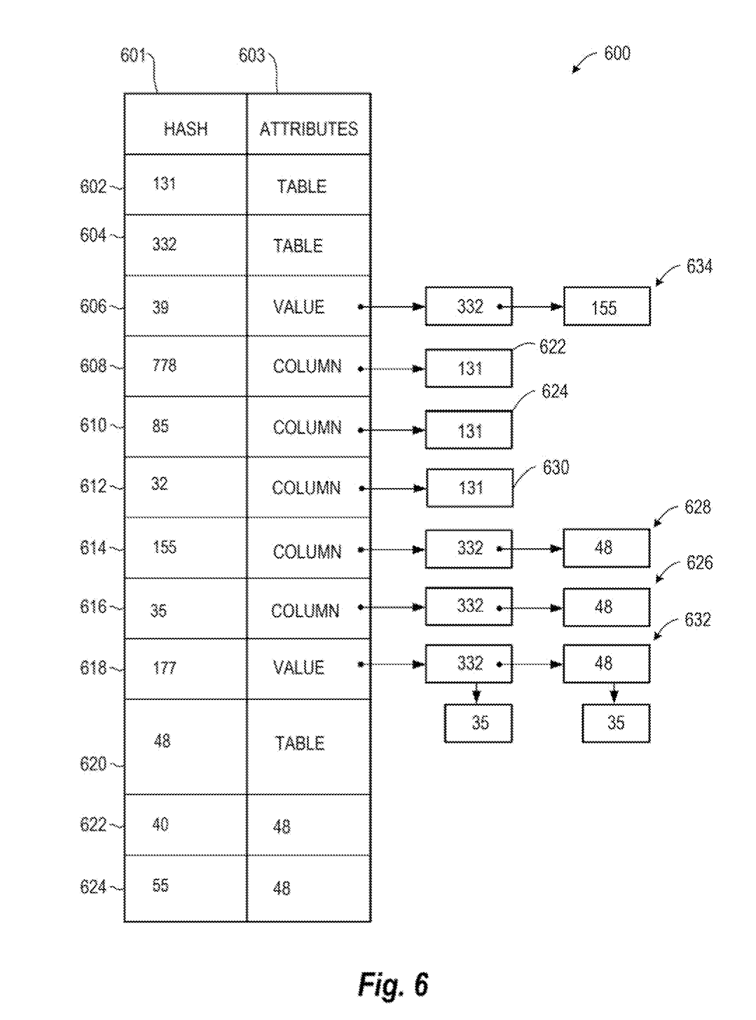

FIG. 5 illustrates a data structure 500 having a plurality of semantic keywords, which may be stored in memory 112. Data structure 500 may have a keyword column 501, a hash code column 503, and associations 502-536 stored therein. Each association 502-536 may include an association between a semantic key word and a hash code. The hash code may be generated by applying a hash function to a corresponding semantic key word. Each semantic keyword may represent at least one attribute of the data base model illustrated in FIG. 4. FIG. 6 illustrates a data structure 600 having a hash code column 601, an attribute column 603, and associations 602-624 stored therein. Each association 602-624 may include an association between a hash code from data structure 500 and at least one attribute of the database model shown in FIG. 4. For example, the semantic keyword “ADDRESS” is associated with hash code 131, as shown in association 502 of FIG. 5. In turn, as shown in association 602 of FIG. 6, hash code 131 is associated with the attribute “TABLE.” Association 602 may notify answer engine module 113 that the semantic keyword “ADDRESS” represents a database table named “ADDRESS” (i.e., address table 400). Accordingly, detection of the word “address” may cause answer-engine module 113 to generate a data base query that searches at least address table 400.

The plurality of semantic keywords shown in FIG. 5 may also comprise synonymous semantic keywords that may be used to disambiguate ambiguous words in the natural language query. Synonymous semantic keywords may be associated with at least one identical attribute of the database model. For example, detection of the words “Staff,” “Worker,” or “Employee” may cause answer engine module 113 to generate a database query that searches at least staff table 430. FIG. 5 shows the semantic keywords “STAFF,” “WORKER,” and “EMPLOYEE” associated with hash codes 48, 40, and 55 respectively. As shown in association 620 of FIG. 6, hash code 48 corresponds to the attribute “TABLE,” which may notify answer engine module 113 that the semantic key word “STAFF” represents a database table named “STAFF” (i.e., staff table 430). Associations 622 and 624 show hash codes 40 and 55 corresponding to hash code 48, which may notify answer engine 113 that they represent the same attribute represented by the semantic keyword associated with hash code 48. Thus, the three synonymous semantic keywords represent the same attribute, staff table 430.

In addition to a table, some semantic keywords may represent a column of a table. For example, in FIG. 5, the semantic keywords “STREET,” “ZIP CODE,” and “CITY” are associated with hash codes 778, 85, and 32 respectively. In FIG. 6, associations 608, 610, and 612 show hash codes 778, 85, and 32 corresponding to the attribute “COLUMN,” which may notify answer engine module 113 that each associated semantic keyword represents some column of the database model. In order to determine the table or tables in which the columns are located, answer engine module 113 may search linked lists 622, 624, and 630. Linked lists 622, 624, and 630 each have one entry containing the hash code 131. Hash code 131 is associated with the semantic keyword “ADDRESS,” which corresponds to the attribute “TABLE,” as shown in association 602. Thus, detection of the word “STREET,” CITY,” or “ZIP CODE” may cause answer engine module 113 to generate a query that at least returns the values of the columns “STREET,” “CITY,” or “ZIP CODE” from address table 400.

In another example, semantic keywords may be associated with database values. As shown in association 526 of FIG. 5, semantic keyword “Mary” may be associated with hash code 177. In association 618 of FIG. 6, hash code 177 may correspond to the attribute “VALUE,” which may notify answer engine module 113 that the semantic keyword “Mary” is a database value. In order to determine the table and column in which the value “Mary” is stored, answer engine module 113 may search linked list 632. Linked list 632 is shown having two pairs of hash codes. The first pair of hash codes in the list is 332/35. As shown in associations 504 and 518 of FIG. 5, hash code 332 is associated with the semantic keyword “CUSTOMER” and hash code 35 is associated with the semantic keyword “FIRST NAME.” Referring back to FIG. 6, hash code 332 is associated with the attribute “TABLE” and hash code 35 is associated with the attribute “COLUMN.” Thus, the first pair of hash codes in linked list 632 may notify answer engine 113 that “Mary” is a value stored in first name column 418 of customer table 414. The second pair of hash codes stored in linked list 632 is 48/35. As shown earlier, in association 532 of FIG. 5, hash code 48 is associated with the semantic keyword “STAFF,” which corresponds to staff table 430, as shown in association 620 of FIG. 6. As demonstrated above, hash code 35 is associated with the semantic keyword “FIRST NAME.” Thus, the semantic keyword “Mary” may either be in first name column 418 of customer table 414 or in first name column 432 of staff table 430.

Referring back to FIG. 3, the natural language query may be translated into at least one database query, as shown in block 306. In one example, a natural language query of “What is Mary's address?” is received. The portions of this query that match the illustrative semantic keywords of FIG. 5 are “Mary” and “address.” In accordance with the illustrative association between the semantic keyword “address” and the address table 400, answer engine module 113 may generate at least one query that searches at least address table 400. As discussed above, the word “Mary” may refer to first name column 418 of customer table 414 or first name column 432 of staff table 430. In view of the two possible attributes associated with “Mary,” answer engine module 113 may generate two separate database queries, such as SQL queries. The following two SQL queries may be generated:
select first_name, last_name, street, zip_code, city
from address, customer
where addressid=customer.custid and
address.first_name=“Mary”
select first_name, last_name street, zip_code, city
from address, staff
where address.id=staff.staffid and
staff.first_name=“Mary”
   Each of the database queries above use a unique combination of attributes of the database model. Each attribute in the unique combination may be represented by a semantic keyword that matches any portion of the natural language query. The first query above will return first name column 418 and last name column 420 of customer table 414 and street column 404, zip code column 406, and city column 408 of address table 400. The first query above also shows address table 400 and customer table 414 being joined via their respective identifiers. The query constraint limits the results to rows containing a value of “Mary” in first name column 418 of customer table 414. The second query above will return first name column 432 and last name column 434 of staff table 430 and street column 404, zip code column 406, and city column 408 of address table 400. The second query above also shows address table 400 and staff table 430 being joined via their respective identifiers. The query constraint limits the results to rows containing a value of “Mary” in first name column 432 of staff table 430. Referring back to FIG. 3, the at least one query may be executed in a database, as shown in block 308. The two generated queries above may be submitted to DBM instructions 114 for execution in database 116. The results may be displayed to a user so as to allow the user to choose the answer that best matches his or her intention.

In another example, the question received is “What is the address of the customer Mary?” This natural language query may cause answer engine module 113 to generate the same two queries above. However, the first query shown above may be ranked higher than the second query based on its relevancy to the received natural language query. Relevancy, as defined herein, comprises a number of one to one associations between attributes used in a query and semantic keywords that match portions of the natural language query. The unique combination of attributes included in a highest ranked database query may cause the database to generate a result that is most relevant to the natural language query when the highest ranked database query is executed therein. The attributes assembled in the first SQL query above are address table 400, customer table 414, and the value “Mary,” which is stored in first name column 418 of customer table 414. In the natural language query “What is the address of customer Mary,” the semantic keywords “address” and “customer” have a one to one association with address table 400 and customer table 414 respectively. As explained above, the semantic keyword “Mary” corresponds to two attributes, first name column 418 and first name column 432. Thus, only two attributes of the first SQL query have a one to one association with a matched semantic keyword. The attributes assembled in the second SQL query above are address table 400, staff table 414, and the value “Mary,” which is stored in first name column 432 of staff table 430. The only one to one association between a matched semantic keyword and an attribute of the second SQL query is between the word “address” and address table 400. The staff table 430 was inserted into the query because “Mary” also corresponds to first name column 432 of staff table 430, but “Mary” does not have a one to one association with a matched semantic keyword. Thus, only one attribute of the second SQL query has a one to one association with a matching semantic keyword. As such, the first query is more relevant than the second query.

The examples disclosed above may be realized in any computer-readable media for use by or in connection with an instruction execution system such as a computer/processor based system, an ASIC, or other system that can fetch or obtain the logic from computer-readable media and execute the instructions contained therein. “Computer-readable media” can be any media that can contain, store, or maintain programs and data for use by or in connection with the instruction execution system. Computer readable media may comprise any one of many physical media such as, for example, electronic, magnetic, optical, electromagnetic, or semiconductor media. More specific examples of suitable computer-readable media include, but are not limited to, a portable magnetic computer diskette such as floppy diskettes or hard drives, RAM, a read-only memory (“ROM”), an erasable programmable read-only memory, or a portable compact disc.

### CONCLUSION

Advantageously, the above-described system and method provides a plurality of results to users entering natural language queries. Rather than trying to generate one query that is deemed most relevant, multiple queries may be generated, ranked, and executed while accounting for ambiguities in the natural language query and the database model. In this regard, users have more flexibility and the likelihood of meeting the intentions of the user is enhanced.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the application as defined by the appended claims. Furthermore, while particular processes are shown in a specific order in the appended drawings, such processes are not limited to any particular order unless such order is expressly set forth herein. Rather, processes may be performed in a different order or concurrently, and steps may be added or omitted.

1. A system comprising:
at least one processor to:
receive a natural language query;
determine whether any portion of the natural language query matches one of a plurality of semantic keywords, each semantic keyword representing at least one attribute of a database model, the plurality of semantic keywords comprising synonymous semantic keywords, the synonymous semantic keywords representing at least one identical attribute of the database model to disambiguate ambiguous words in the natural language query;
translate the natural language query into at least one database query, the at least one database query using a unique combination of attributes of the database model, each attribute in the unique combination being represented by a semantic keyword that matches any portion of the natural language query;
to rank the at least one database query based on a relevancy of each database query such that the relevancy is further based on a number of one to one associations between the unique combination of attributes and the semantic keywords that match portions of the natural language query; and
execute the at least one database query in a database arranged in accordance with the database model.

2. (canceled)

3. The system of claim 1, wherein the unique combination of attributes included in a highest ranked database query causes the at least one processor to generate a result that is most relevant to the natural language query when the highest ranked database query is executed therein.

4. (canceled)

5. The system of claim 1, wherein the at least one processor is a processor to:
apply a hash function to each semantic keyword so as to associate each semantic keyword with a hash code; and
associate each hash code with the at least one attribute of the database model.

6. (canceled)

7. The system of claim 1, wherein the at least one attribute is a database table, a database column, or a database value.

8. A method comprising:
receiving, using at least one processor, a natural language query;
determining, using the at least one processor, whether any portion of the natural language query matches one of a plurality of semantic keywords, each semantic keyword representing at least one attribute of a database model, the plurality of semantic keywords comprising synonymous semantic keywords, the synonymous semantic keywords representing at least one identical attribute of the database model to disambiguate ambiguous words in the natural language query;
translating, using the at least one processor, the natural language query into at least one database query, the at least one database query using a unique combination of attributes of the database model, each attribute in the unique combination being represented by a semantic keyword that matches any portion of the natural language query;
ranking, using the at least one processor, the at least one database query based on a relevancy of each database query such that the relevancy is further based on a number of one to one associations between the unique combination of attributes and the semantic keywords that match portions of the natural language query; and
executing, using the at least one processor, the at least one database query in a database arranged in accordance with the database model.

9. (canceled)

10. The method of claim 8, wherein the unique combination of attributes included in a highest ranked database query causes the at least one processor to generate a result that is most relevant to the natural language query when the highest ranked database query is executed therein.

11. (canceled)

12. The method of claim 8, further comprising
applying, using the at least one processor, a hash function to each semantic keyword so as to associate each semantic keyword with a hash code; and
associating, using the at least one processor, each hash code with the at least one attribute of the database model.

13. (canceled)

14. The method of claim 8, wherein the at least one attribute is a database table, a database column, or a database value.

15. A non-transitory computer readable medium having instructions stored therein, which if executed, cause at least one processor to:
receive a natural language query;
determine whether any portion of the natural language query matches one of a plurality of semantic keywords, each semantic keyword representing at least one attribute of a database model, the plurality of semantic keywords comprising synonymous semantic keywords, the synonymous semantic keywords representing at least one identical attribute of the database model to disambiguate ambiguous words in the natural language query;
translate the natural language query into a at least one database query, the at least one database query using a unique combination of attributes of the database model, each attribute in the unique combination being represented by a semantic keyword that matches any portion of the natural language query;
rank the at least one database query based on a relevancy of each database query such that the relevancy is further based on a number of one to one associations between the unique combination of attributes and the semantic keywords that match portions of the natural language query; and
execute the at least one database query in a database arranged in accordance with the database model.

16. (canceled)

17. The non-transitory computer readable medium of claim 15, wherein the unique combination of attributes included in a highest ranked database query causes the at least one processor to generate a result that is most relevant to the natural language query when the highest ranked database query is executed therein.

18. (canceled)

19. The non-transitory computer readable medium of claim 15, wherein the instructions if executed further cause the at least one processor to:
apply a hash function to each semantic keyword so as to associate each semantic keyword with a hash code; and
associate each hash code with the at least one attribute of the database model.

20. (canceled)
